(19) United States
(12) Patent Application Publication
(10) Pub. No.: US 2021/0169272 A1
(43) Pub. Date: Jun. 10, 2021

(54) FLARE RESISTANT EASY TO CLEAN GRILL FOR COOKING FOOD

(71) Applicant: 2723978 ONTARIO INC., Toronto (CA)

(72) Inventors: Thomas Franz Josef GEHRING, Toronto (CA); Matthew Thomas GEHRING, Toronto (CA); Sylvia Christiane GEHRING, Toronto (CA)

(73) Assignee: 2723978 ONTARIO INC.

(21) Appl. No.: 17/117,791

(22) Filed: Dec. 10, 2020

Related U.S. Application Data
(60) Provisional application No. 62/946,181, filed on Dec. 10, 2019.

(51) Int. Cl. A47J 37/07

(52) U.S. Cl. CPC A47J 37/0786; A47J 37/0704

(57) ABSTRACT

The disclosed grill resists flare-ups by catching drippings from the food in channels or trenches attached to grill elements that are easy to clean as the ends are left open. The grill elements are slanted so that there are spaces for heated air from below the grill to flow to the top of the grill, but viewed from the top these spaces cannot be seen. In one embodiment, the grill is tilted so that drippings flow towards one side of the grill, away from the heating elements below the food. Optionally, the grill elements may be detachably attached to the supporting rails for easier cleaning.

### REFERENCE TO RELATED APPLCLICATIONS

This application claims the benefit of U.S. provisional application No. 62/946,181.

### FIELD OF THE INVENTION

The field of this invention is grills for cooking food.

### BACKGROUND

Flare-ups are a known problem with cooking, particularly on barbeques. Flare-ups occur when the grease from the food drips onto the heating elements below the grill, causing flames which can burn the food, or otherwise affect the cooking of the food in undesirable ways (for example, over-cooking one side of the food). Typical existing grills—essentially a series of metal rods placed above the heating elements on which food is rested during cooking—do not prevent flare-ups.

Grills also need to be cleaned after use.

It is desirable to have a grill that helps to prevent flare-ups and allows for easier cleaning.

### SUMMARY

The grills disclosed in this application addresses this need by proposing a grill with multiple grilling elements, each of which has a top surface for cooking food. Each grilling element also has a trench running along the length of this grilling element. The grilling elements are attached to rails that support and connect the grilling elements.

The grilling elements and trenches are not closed at the end, which makes them easy to clean.

The grilling elements have spaces or openings between them, to allow hot air to pass through the grill. In order for the trenches to catch drippings from the food, the grilling elements need to be slanted and/or shaped so that the drippings run down the sides of the grilling elements or otherwise end up in the trenches. Seen from above, ideally the spaces between the grill elements should not be visible. Ideally, the top surfaces of the grilling element should overhang the trench of the adjacent grilling elements. In a preferred embodiment, the grilling elements seen from the side are a slanted s-shape: the slant is oriented to direct drippings from the food into the trenches.

In one embodiment, the rails are of different sizes, thus allowing the drippings and grease to run to one side of the grill, where they can be dealt with.

In an optional embodiment, the grilling elements include tabs that are designed to wrap around the prongs of the rails, and the grilling elements are detachably attached to the rails.

In accordance with the present invention, there is provided a grill for cooking above a heat source comprising: two or more grill elements, each grill element having a length, each grill element including a top surface located opposite the heat source, each grill element including a trench running along the length of the grill element, the ends of the trenches being left open and the ends of the grill elements being left open, and the grill elements being slanted to direct liquids falling onto the grill from above the grill into the trenches. In an aspect of this invention, the grill elements are placed and slanted so that the top of each grill element overhangs the trench of the adjacent grill element. In another aspect, the two or more grill elements are arranged so that there are openings between the grill elements, and the grill elements being slanted so that, when viewed looking perpendicularly down on the top surfaces of the grill elements, the openings between the grill elements cannot be seen. In another aspect of this invention, there are at least two rails, and the grill elements are attached to the at least two rails. In a further aspect, the at least two rails are sized to tilt the trenches. In another aspect, the there are at least two rails, and the grill elements are detachably attached to the at least two rails. In a further aspect, the at least two rails are sized to tilt the trenches, and the grill elements are detachably attached to the at least two rails. In another aspect, the at least two rails have fingers, and the grill elements have tabs, and the tabs are detachably attached to the fingers.

In accordance with the present invention, there is provided a grill for cooking above a heat source comprising: two or more grill elements, each grill element having a length, each grill element including a top surface located opposite the heat source, each grill element including a trench running along the length of the grill element, the ends of the trenches being closed with a hole pierced therethrough, and the grill elements being slanted to direct liquids falling onto the grill from above the grill into the trenches. In an aspect of this invention, the grill elements are placed and slanted so that the top of each grill element overhangs the trench of the adjacent grill element. In another aspect, the two or more grill elements are arranged so that there are openings between the grill elements, and the grill elements being slanted so that, when viewed looking perpendicularly down on the top surfaces of the grill elements, the openings between the grill elements cannot be seen. In another aspect of this invention, there are at least two rails, and the grill elements are attached to the at least two rails. In a further aspect, the at least two rails are sized to tilt the trenches. In another aspect, the there are at least two rails, and the grill elements are detachably attached to the at least two rails. In a further aspect, the at least two rails are sized to tilt the trenches, and the grill elements are detachably attached to the at least two rails. In another aspect, the at least two rails have fingers, and the grill elements have tabs, and the tabs are detachably attached to the fingers.

### DESCRIPTION OF THE FIGURES

A grill suitable for use on a barbeque is disclosed.

FIG. 1 is an isometric view of a first embodiment of the grill.

FIG. 2 is a front view of the first embodiment of the grill.

FIG. 3 is a right side view of the first embodiment of the grill.

FIG. 4 is a top view of the first embodiment of the grill.

FIG. 5 is a bottom view of the first embodiment of the grill.

FIG. 6 is an enlarged fragmentary view of FIG. 1.

FIG. 7 is a first enlarged fragmentary view of FIG. 2.

FIG. 8 is a second enlarged fragmentary view of FIG. 2.

FIG. 9 is an enlarged fragmentary view of FIG. 3.

FIG. 10 is a second isometric view of the grill of FIG. 1.

FIG. 11 is an enlarged fragmentary view of FIG. 10.

FIG. 12 is an isometric view of a second embodiment of the grill.

FIG. 13 is a front view of the second embodiment of the grill.

FIG. 14 is a right side view of the second embodiment of the grill.

FIG. 15 is a top view of the second embodiment of the grill.

FIG. 16 is a bottom view of the second embodiment of the grill.

FIG. 17 is an enlarged fragmentary view of FIG. 12.

FIG. 18 is a first enlarged fragmentary view of FIG. 13.

FIG. 19 is a second enlarged fragmentary view of FIG. 13.

FIG. 20 is an enlarged fragmentary view of FIG. 14.

FIG. 21 is a second isometric view of the grill of FIG. 12.

FIG. 22 is an enlarged fragmentary view of FIG. 21.

FIG. 23 shows tabs which can be used to detachable attach the grills pictured in FIG. 1 and FIG. 12 to the rails, as seen in FIGS. 24 and 25.

FIG. 24 shows the rails without the grilling elements.

FIG. 25 shows the grilling elements of FIG. 23 detachable attached to the grills of FIG. 24.

### DETAILED DESCRIPTION

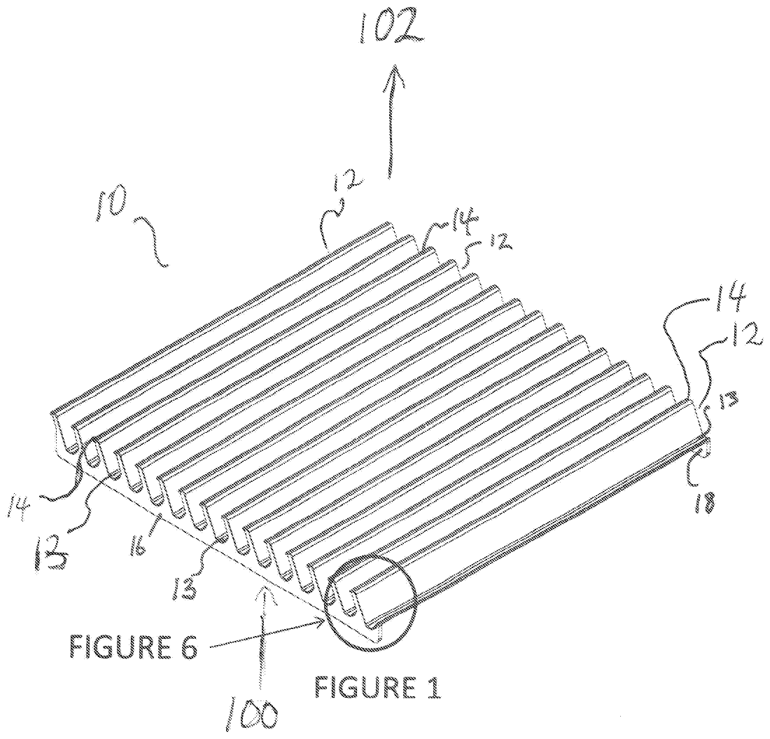

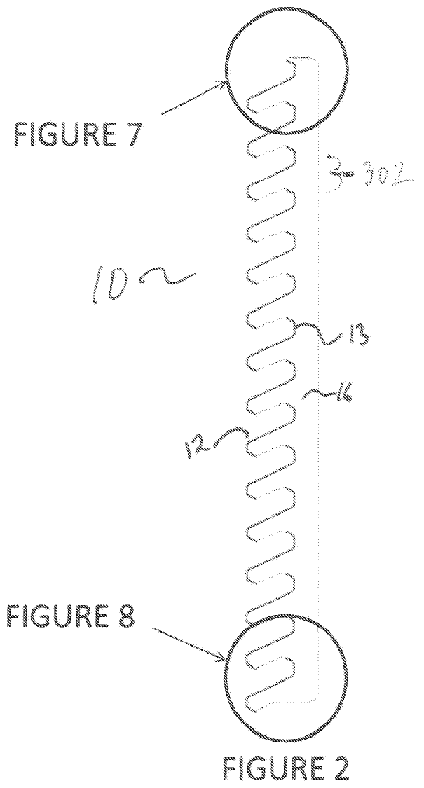

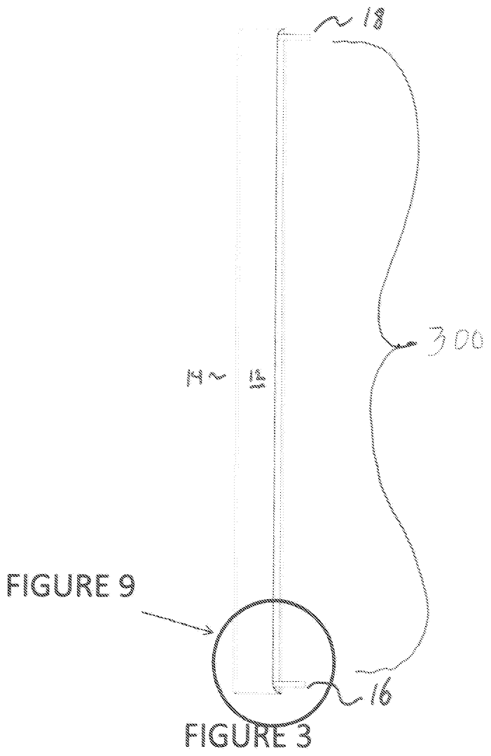

FIG. 1 is an isometric view of a first embodiment of the grill. Turning to FIG. 1, there is a grill 10 with two or more elongated grill elements 12, elongated meaning that they have a length dimension 300 (please see FIG. 3) that is greater in relation to their width dimension 302 (please see FIG. 2). Each grill element has a top surface 14 and a trench 13 running generally along the length of the grill element 12. Supporting the grill elements 12 are rails 16 and 18. In use, the grill is placed above a heat source so that heat flows in direction 100 up through the grill (i.e. arrow 100 is pointing towards the bottom of the grill) in direction 102 (i.e. arrow 102 is pointing away from the top of the grill).

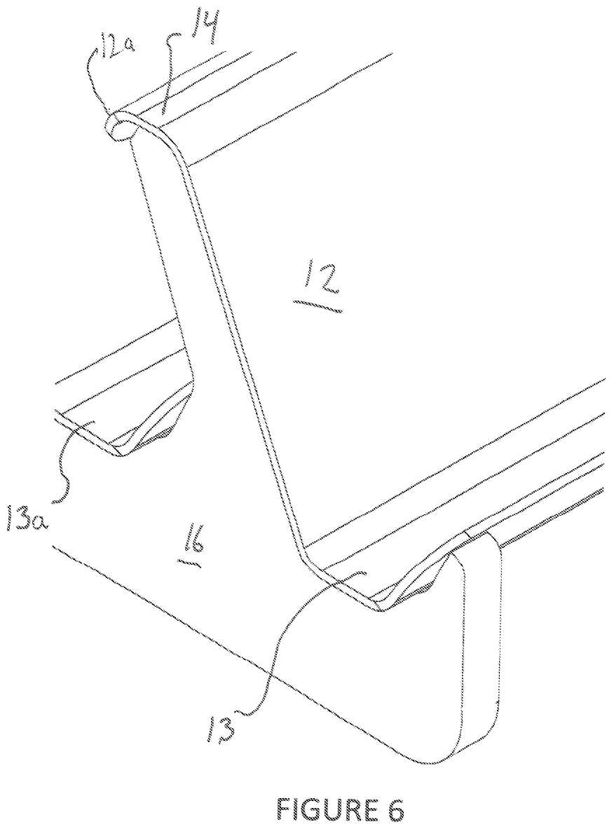

FIG. 6 is an enlarged fragmentary view of the isometric view of FIG. 1, showing rail 16 and a grill element 12 with a top surface 14 and forming a trench 13. The grill-element 12 is s-shaped or slanted so as to funnel drippings from food sitting on top surface 14 into trench 13, but s-shaped grill element 12 also overhangs the trench 13a of the neighbouring grill element funnel drippings from the other side 12a of grill element 12 into trench 13a.

FIG. 2 is a front view of the first embodiment of the grill. Turning to FIG. 2, it can be seen that rail 16 is shaped to support the curves and structure and slant of grill elements 12. Each grill element 12 has an S-shaped or slanted profile as seen from this view. Rail 18 is also shaped to support the curves and structure and slant of grill elements 12. Each grill element 12 has a width 302.

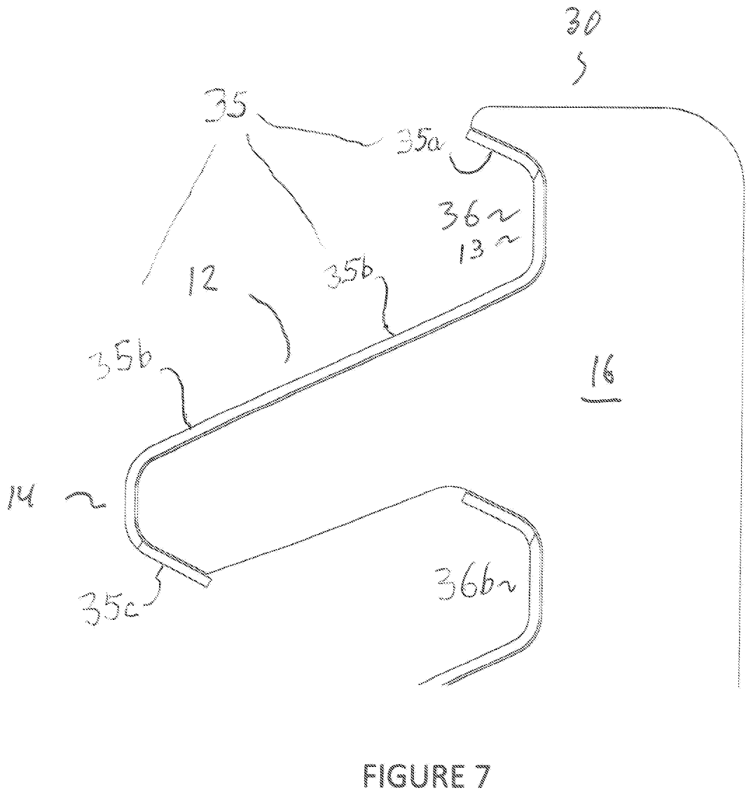

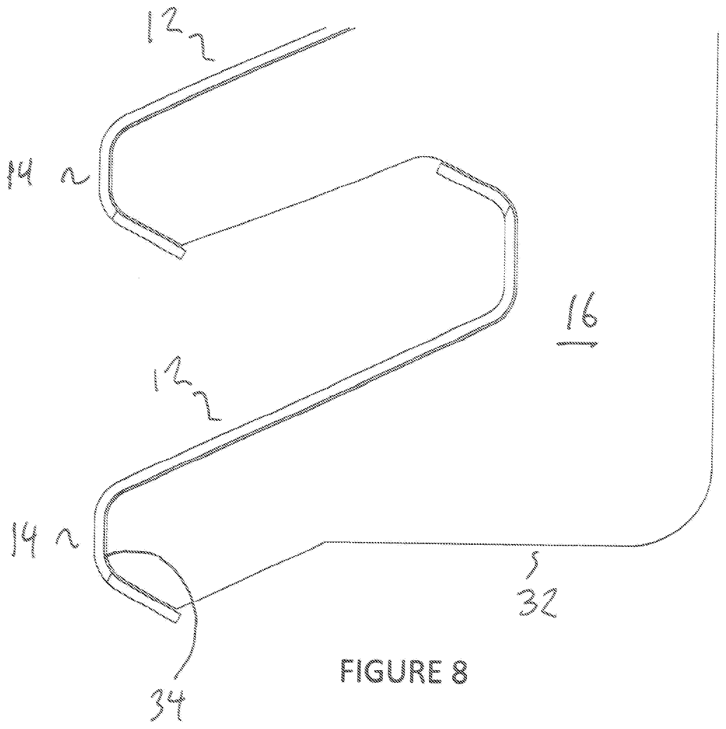

FIG. 7 is an enlarged fragmentary view of FIG. 2. Turning to FIG. 7, rail 16 is shaped to support the curves and structure and slant of grill elements 12. FIG. 8 is an enlarged fragmentary view of FIG. 2. Turning to FIG. 8, rail 16 is shaped to support the curves and structure and slant of grill elements 12. Surface 30 of FIG. 7 is sized so as to be able to nest against surface 32 of FIG. 8 when two grills 10 are placed side by side, so that the top of grill element 34 in FIG. 8 overhangs the trench 36 in FIG. 7.

Turning to FIG. 7, the s-shaped grill element is covered by surface 35 (having surfaces 35a, 35b and 35c) which is designed to funnel drippings from food into trench 36, but also surfaces 35 overhangs trench 36c, and surface 35c is shaped to funnel drippings into trench 36b.

Note that because rails 16 and 18 support the grill elements 12 from below, the ends of trenches 13 and the ends of top surfaces 14 are not closed. In the preferred embodiment shown in FIG. 7, the ends of the trenches 12 and top surfaces 14 are left open. The tops and ends of these trenches being open makes it possible to more easily clean the grill and allows drippings, fat and juices to run out of trenches 13. In other embodiments, the ends of the trenches 12 and top surfaces 14 are closed but have an opening therethrough to allow drippings to escape.

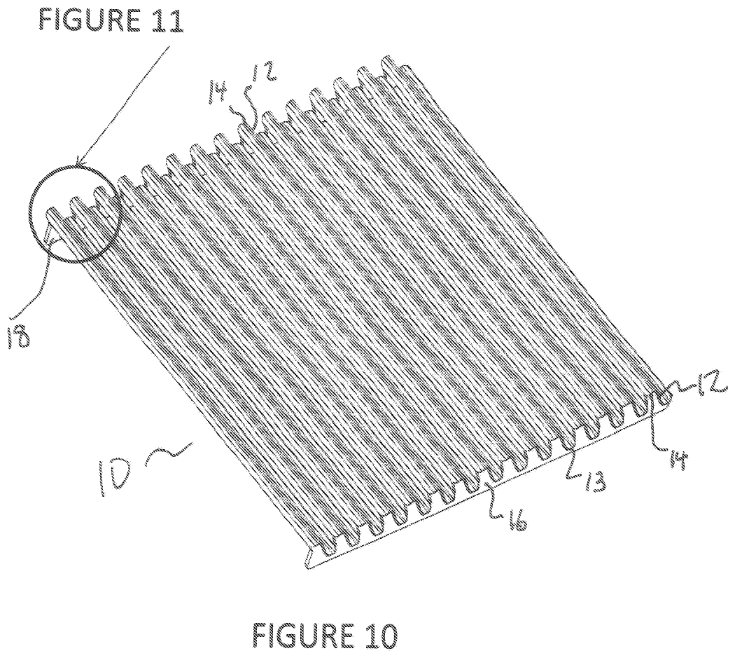

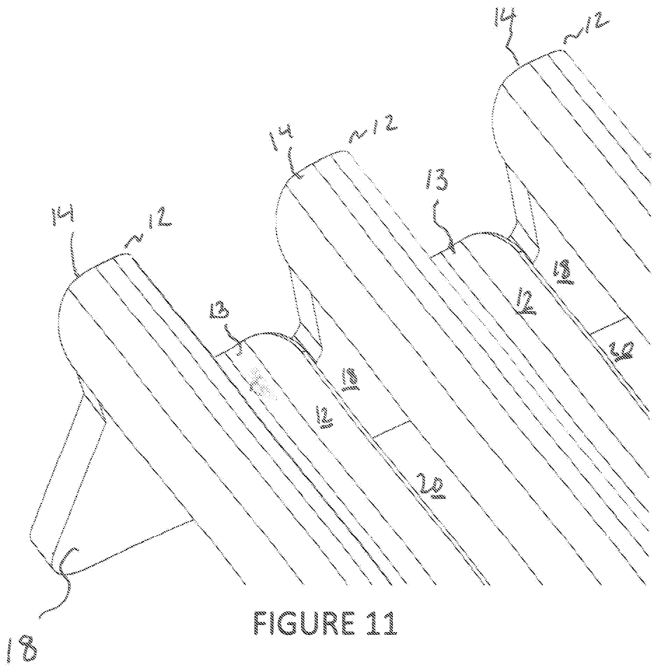

FIG. 10 is a second isometric view of the grill of FIG. 1. Turning to FIG. 10 there is the grill 10 with two or more grill elements 12, each with a top surface 14. Supporting the grill elements 12 are rails 16 and 18. FIG. 11 is an enlarged fragmentary view of FIG. 10. Turning to FIG. 11, rail 18 is shaped to support the curves and structure and slant of grill elements 12, each of which has a top surface 14. There are openings 20 between each grill element 12. These openings 20 allow heat to pass from beneath to above the grill (in directions 100 and 102 as seen in FIG. 1).

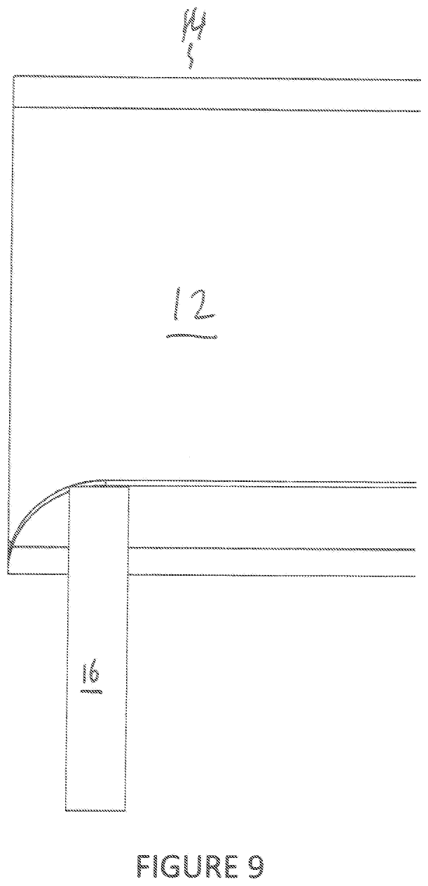

FIG. 3 is a right side view of the grill of FIG. 1, showing rails 16 and 8, and a grill element 12 with a top surface 14 and a trench 13. FIG. 9 is an enlarged view of a section of FIG. 3, showing rail 16 and a grill element 12 with a top surface 14. Each grill element 12 has a length 300.

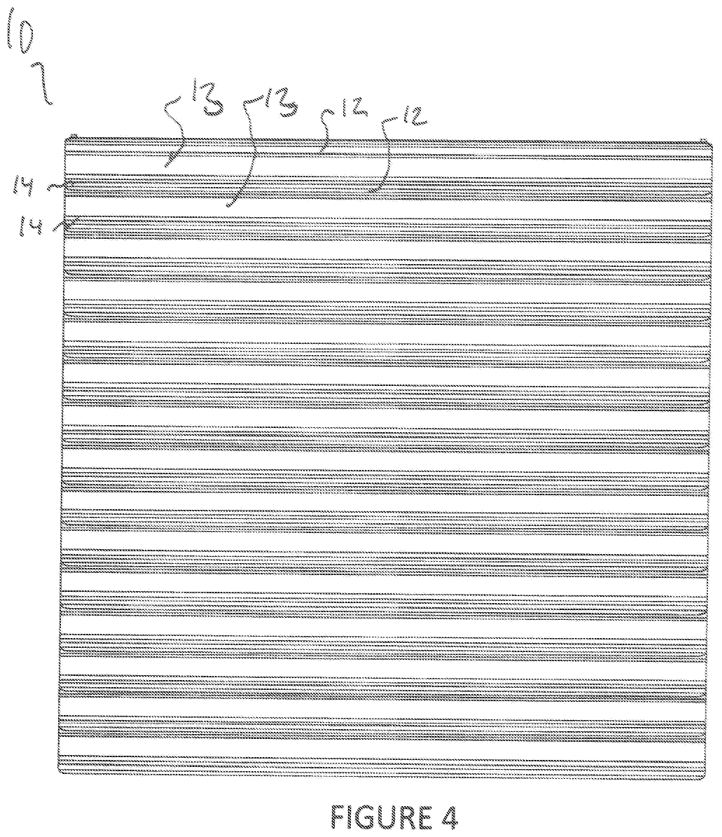

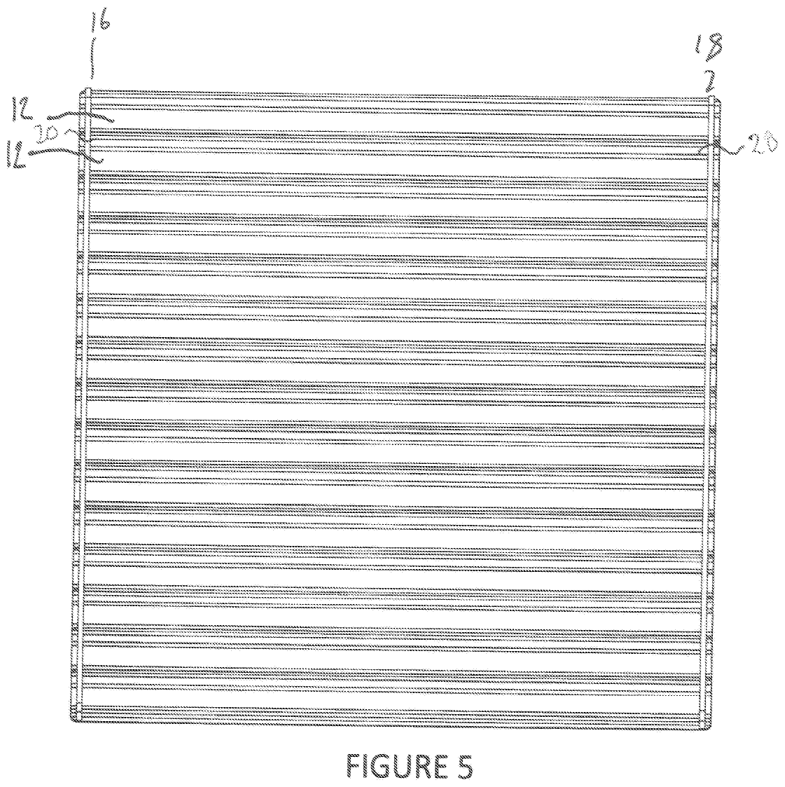

FIG. 4 is a top view of the grill of FIG. 1, showing two or more grill elements 12 with top surfaces 14 and trenches 13. FIG. 5 is a bottom view of the grill of FIG. 1, showing rails 16 and 18 as well as a two or more grill elements 12 and openings 20. The top view in FIG. 4 is from a perspective perpendicular to the top surfaces 12. In a preferred embodiment, from the perspective in FIG. 4, the openings 20 between the grill elements 12 cannot be seen.

In use, the grill 10 is placed over a heating means and the food cooks on top surfaces 14. Fat or drippings escaping from the food falls into and is channelled along trench 13, thus minimizing flare-ups (which usually occur when fat escapes from the food and falls directly into the heating means below the grill). However, heated air can still pass through the grill 10 through spaces 20. Note that since the heated air is passing by trenches containing drippings from the food, this may enhance the flavour of the food as it cooks. In a preferred embodiment, the openings 20 cannot be seen from the perspective of FIG. 4, as this will provide the best protection against flare-ups. However, this grill can still function to restrict flare-ups even if some of the openings are visible from above.

The ends of trenches 13 and the ends of top surfaces 14 are open. This allows for the easier cleaning of the grill 10, compared to grills where trenches or similar structures are closed at the ends.

In a second embodiment of the invention, the rails are of different sizes so that drippings or fat falling into the trenches is funnelled to one side of the grill, where it can be dealt with in a graceful manner so as to avoid flare-ups.

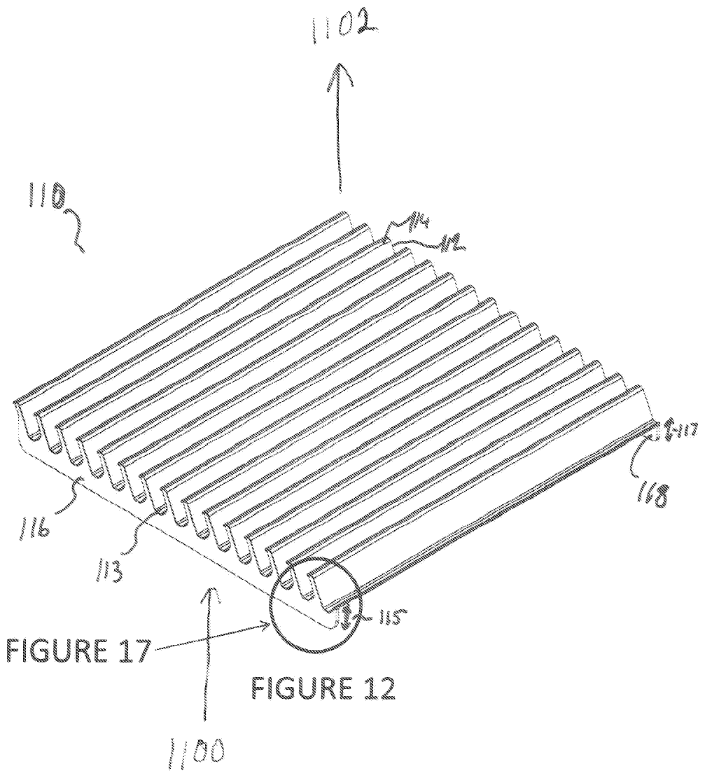

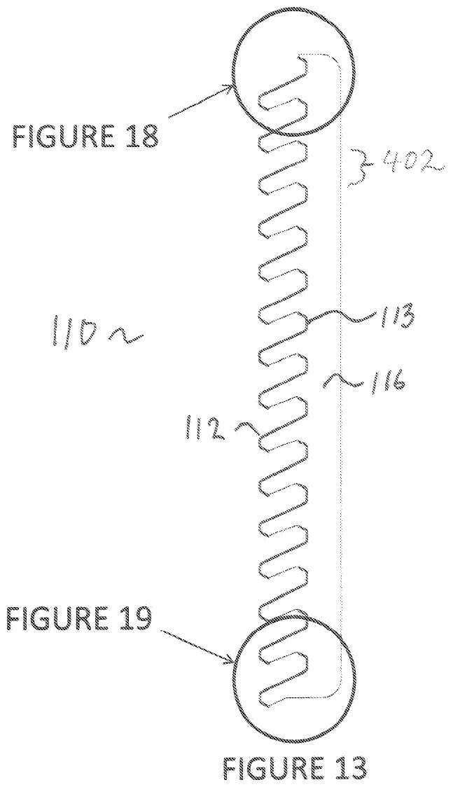

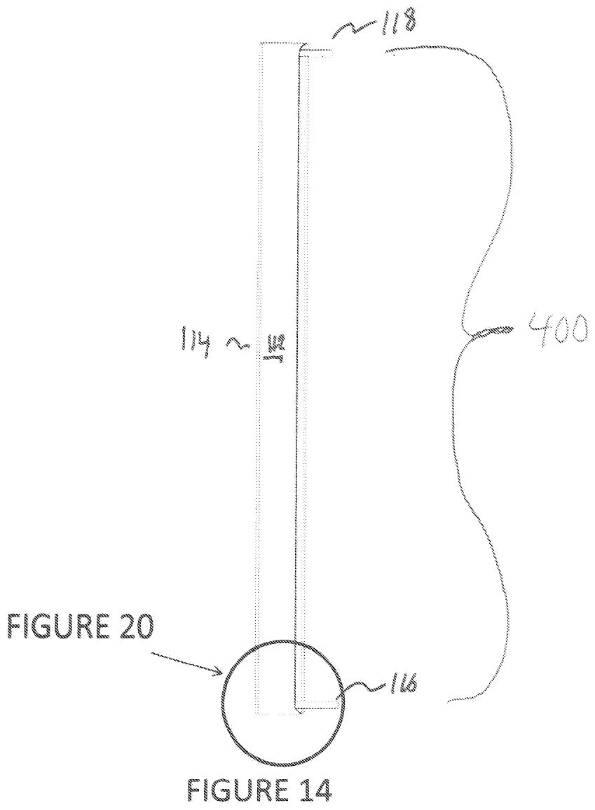

FIG. 12 is an isometric view of the second embodiment of the grill. Turning to FIG. 12, there is a grill 110 with two or more elongated grill elements 112, elongated meaning that they have a length dimension 400 (please see FIG. 14) that is greater in relation to their width dimension 401 (please see FIG. 13). Each grill element 112 has a top surface 114 and a trench 113 running generally along the length of the grill element 112. Supporting the grill elements 112 are rails 116 and 118. In use, the grill is placed above a heat source so that heat flows in direction 1100 up through the grill (i.e. arrow 1100 is pointing towards the bottom of the grill) in direction 1102 (i.e. arrow 1102 is pointing away from the top of the grill).

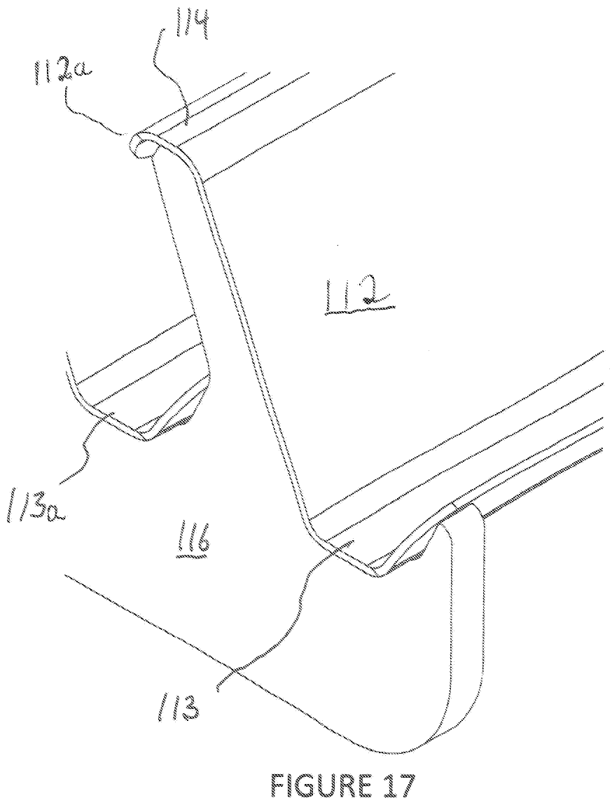

FIG. 17 is an enlarged fragmentary view of the isometric view of FIG. 12, showing rail 116 and a grill element 112 with a top surface 114 and forming a trench 113. The grill-element 112 is s-shaped or slanted so as to funnel drippings from food sitting on top surface 114 into trench 113, but s-shaped grill element 112 also overhangs the trench 113a of the neighbouring grill element funnel drippings from the other side 112a of grill element 112 into trench 113a.

Rail 116 is larger than rail 118, so that when grill 110 is laid upon a flat surface, the grill elements 112 are tilted. Dimension 115 of rail 116 is larger than dimension 117 of rail 118.

FIG. 13 is a front view of the first embodiment of the grill. Turning to FIG. 13, it can be seen that rail 116 is shaped to support the curves and structure and slant of grill elements 112. Each grill element 112 has an S-shaped profile as seen from this view. Rail 118 is also shaped to support the curves and structure and slant of grill elements 112.

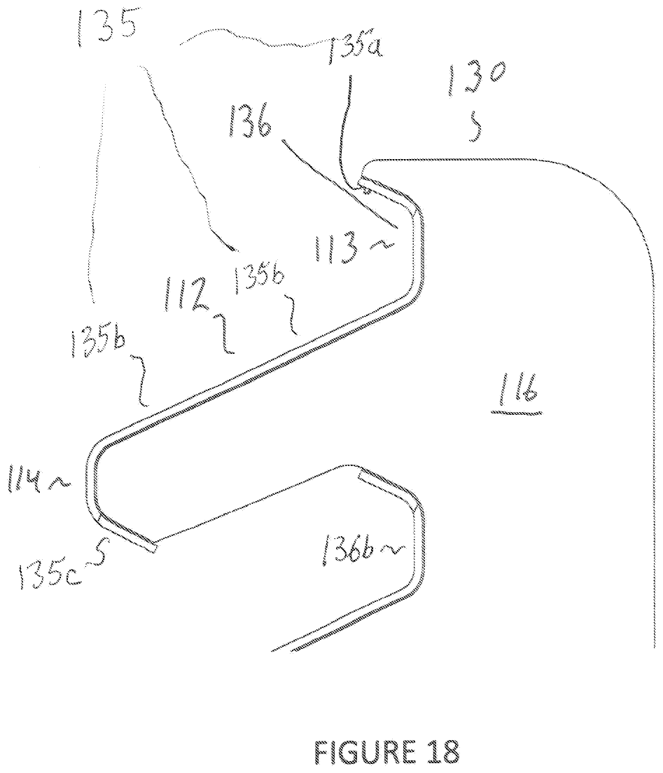

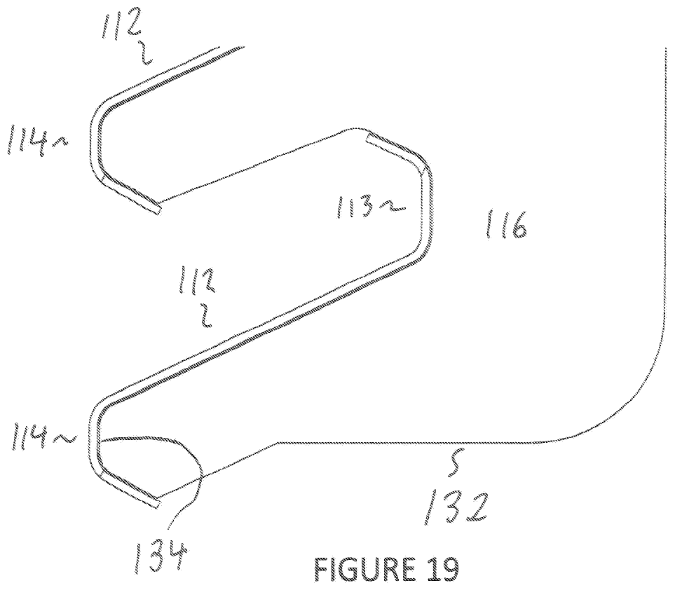

FIG. 18 is an enlarged fragmentary view of FIG. 13. Turning to FIG. 18, rail 116 is shaped to support the curves and structure and slant of grill elements 112. FIG. 19 is an enlarged fragmentary view of FIG. 13. Turning to FIG. 19, rail 116 is shaped to support the curves and structure and slant of grill elements 112. Surface 130 of FIG. 18 is sized so as to be able to nest against surface 132 of FIG. 19 when two grills 110 are placed side by side, so that the top of grill element 134 in FIG. 19 overhangs the trench 136 in FIG. 18.

Turning to FIG. 18, the s-shaped grill element is covered by surface 135 (having surfaces 135a, 135b and 135c) which is designed to funnel drippings from food into trench 136, but also surfaces 135 overhangs trench 136c, and surface 135c is shaped to funnel drippings into trench 136b.

Note that because rails 116 and 118 support the grill elements 112 from below, the ends of trenches 113 and the ends of top surfaces 114 are not closed. In the preferred embodiment in FIG. 18, the ends of trenches 112 and top surfaces 114 are left open. The tops and ends of these trenches being open makes it possible to more easily clean the grill and allows droppings, fat and juices to run out of trenches 113. In other embodiments, the ends of the trenches 112 and top surfaces 114 are closed but have an opening therethrough to allow drippings to escape.

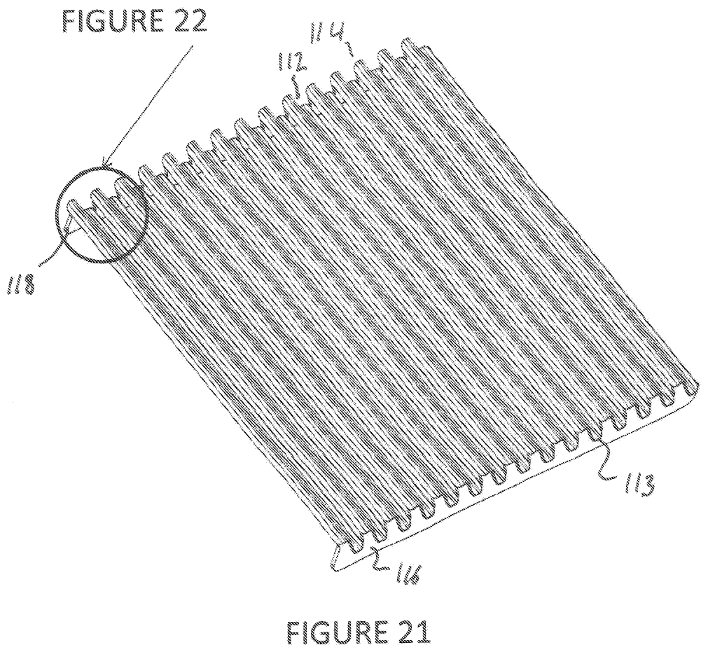

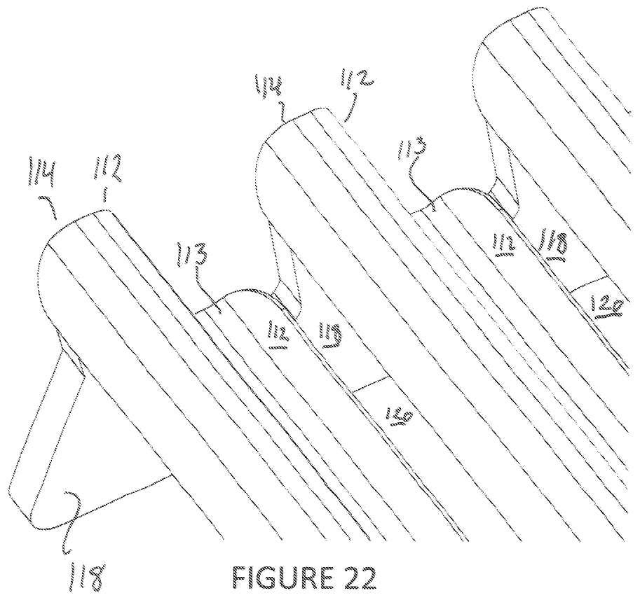

FIG. 21 is a second isometric view of the grill of FIG. 12. Turning to FIG. 21 there is the grill 110 with two or more grill elements 112, each with a top surface 114. Supporting the grill elements 112 are rails 116 and 118. FIG. 22 is an enlarged fragmentary view of FIG. 21. Turning to FIG. 22, rail 118 is shaped to support the curves and structure and slant of grill elements 112, each of which has a top surface 114. There are openings 120 between each grill element 112. These openings 120 allow heat to pass from beneath to above the grill (in directions 1100 and 1102 as seen in FIG. 12).

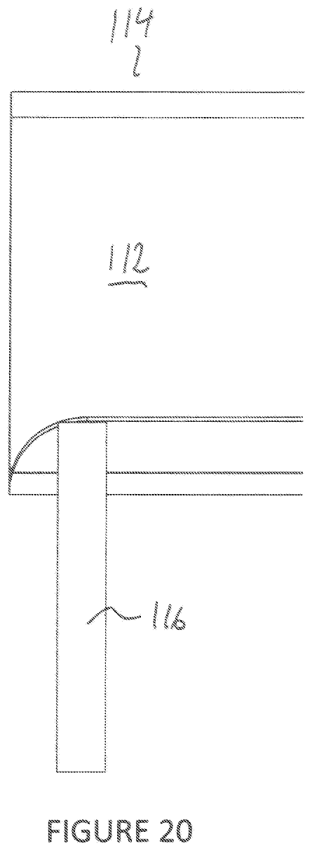

FIG. 14 is a right side view of the grill of FIG. 12, showing rails 116 and 118, and a grill element 112 with a top surface 114 and a trench 113. FIG. 20 is an enlarged view of a section of FIG. 14, showing rail 116 and a grill element 112 with a top surface 114. Each grill element has a length 400.

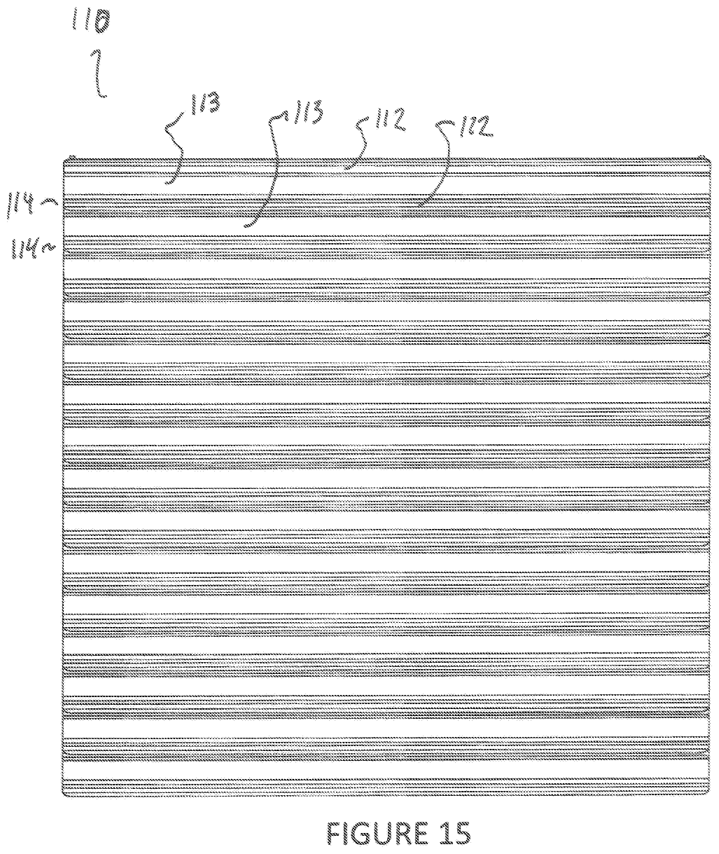

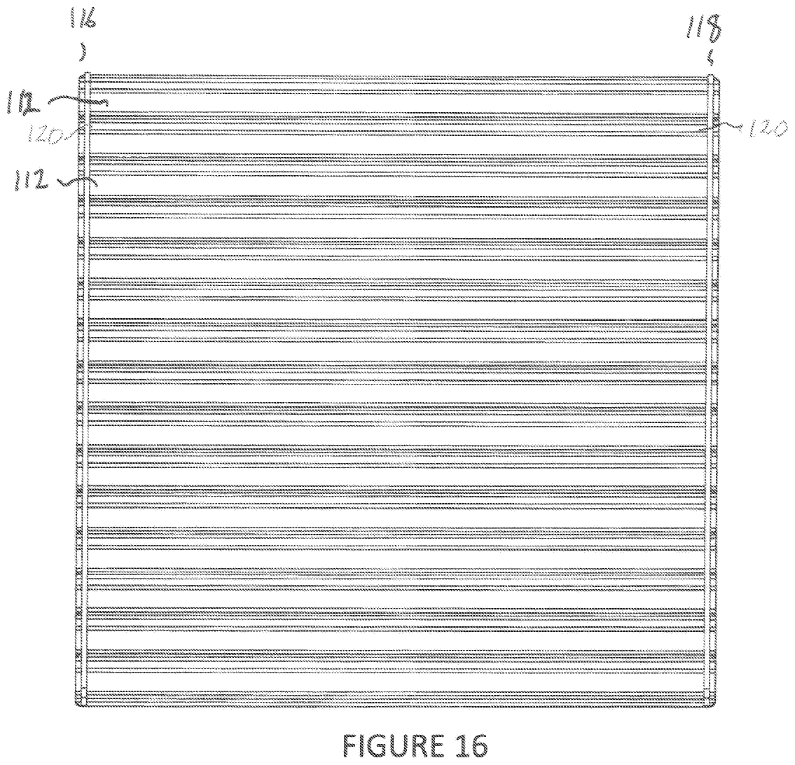

FIG. 15 is a top view of the grill of FIG. 12, showing two or more grill elements 112 with top surfaces 114 and trenches 113. FIG. 16 is a bottom view of the grill of FIG. 12, showing rails 116 and 118 as well as two or more grill elements 112 and openings 120. The top view in FIG. 15 is from a perspective perpendicular to the top surfaces 112. In a preferred embodiment, from the perspective in FIG. 5, the openings 120 between the grill elements 112 cannot be seen.

In use, the grill 110 is placed over a heating means and the food cooks on top surfaces 114. Fat or drippings escaping from the food falls into and is channelled along trench 113, thus minimizing flare-ups (which usually occur when fat escapes from the food and falls directly into the heating means below the grill). However, heated air can still pass through the grill 110 through gaps or spaces 120. Since rail 116 is larger than rail 118, fat dripping into trench 113 is funneled along trench 113 towards rail 118, where it can be disposed of in a manner than minimizes the chance of food-burning flare-ups. In a preferred embodiment, the openings 120 cannot be seen from the perspective of FIG. 15, as this will provide the best protection against flare-ups. However, this grill can still function to restrict flare-ups even if some of the openings are visible from above.

Since the ends of trenches 113 and the ends of top surfaces 114 are left open, the trenches 113 and top surfaces 114 of the grill 110 are easily cleaned.

If desired, in either the embodiment of FIG. 1 or the embodiment of FIG. 12, additional rails may be used in the same manner as rails 16 and 18 (or 116 and 118) for additional support.

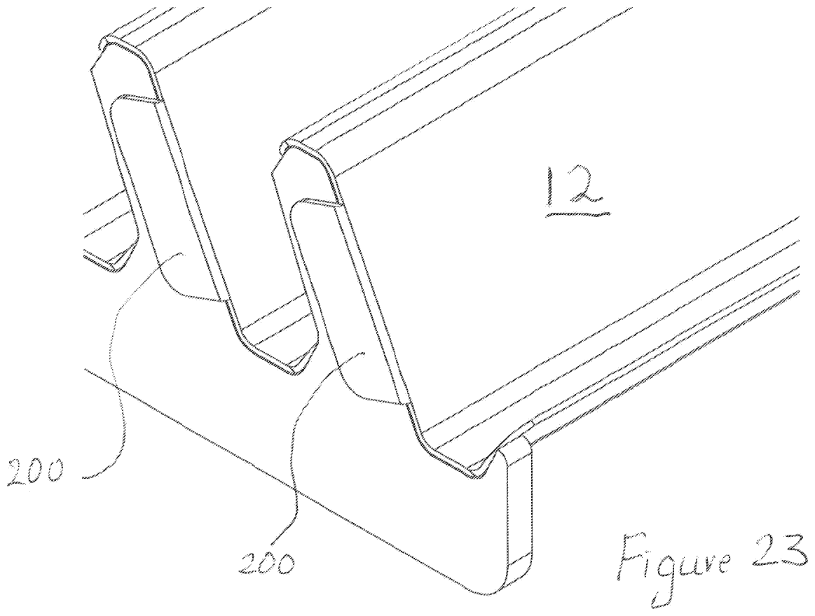

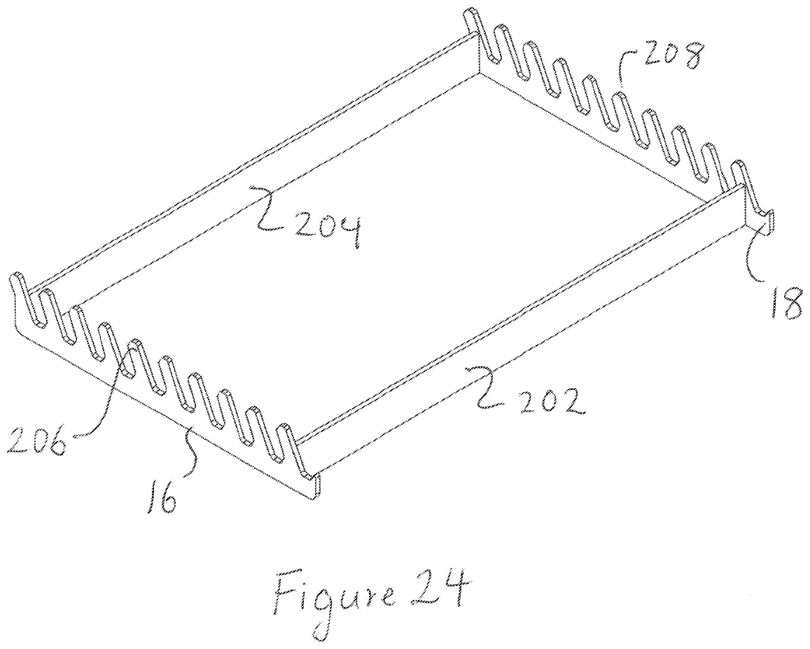

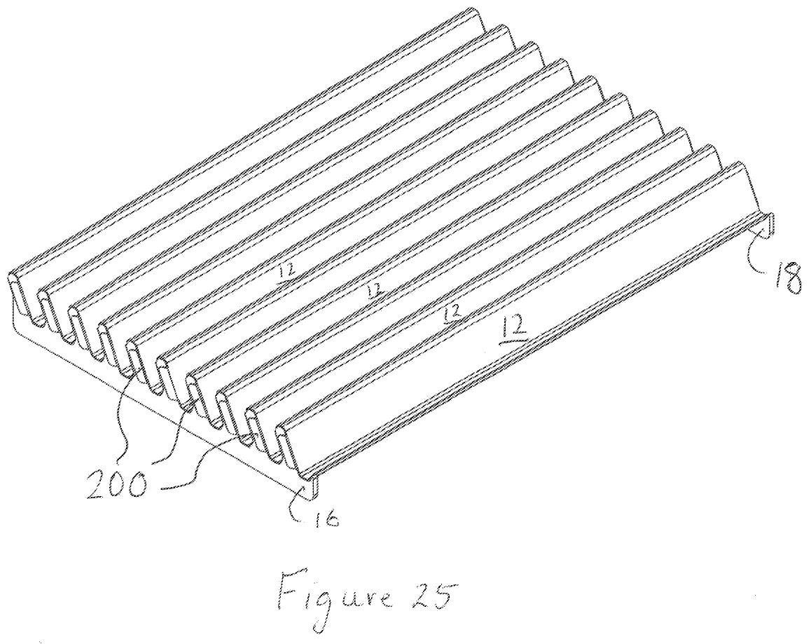

As an additional option for the embodiment of FIG. 1 or the embodiment of FIG. 12, turning to FIG. 23, at least one tab 200 can be added to the ends of grill elements 12 (or equivalently 112) to provide detachable attachment of the grill elements 12 (or equivalently 112) to rails 16 and 18 (or equivalents 116 and 118). Turning to FIG. 24, rails 16 and 18 have fingers 206 and 208 and are connected by support members 202 and 204. Tabs 200 fit around fingers 206 and 208 so that grill elements 12 are detachably attached to rails 16 and 18. FIG. 25 shows multiple grill elements 12 detachably attached to rails 16 and 18. Although FIGS. 23, 24 and 25 have been discussed in terms of the first embodiment seen in FIG. 1, the same approach may be used with the second embodiment grill of FIG. 12. The detachably attached grill elements allows for easier cleaning of the grill and grill elements, and for easier repair and maintenance.

What is claimed is:

1. A grill for cooking above a heat source comprising:
Two or more grill elements, each grill element having a length, each grill element including a top surface located opposite the heat source, each grill element including a trench running along the length of the grill element, the ends of the trenches being left open and the ends of the grill elements being left open, and the grill elements being slanted to direct liquids falling onto the grill from above the grill into the trenches.

2. The grill of claim 1, where the grill elements are placed and slanted so that the top of each grill element overhangs the trench of the adjacent grill element.

3. The grill of claim 2, further comprising: the two or more grill elements being arranged so that there are openings between the grill elements, and the grill elements being slanted so that, when viewed looking perpendicularly down on the top surfaces of the grill elements, the openings between the grill elements cannot be seen.

4. The grill of claim 3, further comprising at least two rails, and the grill elements attached to the at least two rails.

5. The grill of claim 4, wherein the at least two rails are sized to tilt the trenches.

6. The grill of claim 4, where the grill elements are detachably attached to the at least two rails.

7. The grill of claim 5, where the grill elements are detachably attached to the at least two rails.

8. The grill of claim 6, where the at least two rails have fingers, and the grill elements have tabs, and the tabs are detachably attached to the fingers.

9. The grill of claim 7, where the at least two rails have fingers, and the grill elements have tabs, and the tabs are detachably attached to the fingers.

10. A grill for cooking above a heat source comprising:
Two or more grill elements, each grill element having a length, each grill element including a top surface located opposite the heat source, each grill element including a trench running along the length of the grill element, the ends of the trenches being closed with a hole pierced therethrough, and the grill elements being slanted to direct liquids falling onto the grill from above the grill into the trenches.

11. The grill of claim 10, where the grill elements are placed and slanted so that the top of each grill element overhangs the trench of the adjacent grill element.

12. The grill of claim 11, further comprising: the two or more grill elements being arranged so that there are openings between the grill elements, and the grill elements being slanted so that, when viewed looking perpendicularly down on the top surfaces of the grill elements, the openings between the grill elements cannot be seen.

13. The grill of claim 12, further comprising at least two rails, and the grill elements attached to the at least two rails.

14. The grill of claim 13, wherein the at least two rails are sized to tilt the trenches.

15. The grill of claim 13, where the grill elements are detachably attached to the at least two rails.

16. The grill of claim 14 where the grill elements are detachably attached to the at least two rails.

17. The grill of claim 15, where the at least two rails have fingers, and the grill elements have tabs, and the tabs are detachably attached to the fingers.

18. The grill of claim 16, where the at least two rails have fingers, and the grill elements have tabs, and the tabs are detachably attached to the fingers.
